(19) United States
(12) Patent Application Publication
(10) Pub. No.: US 2022/0254262 A1
(43) Pub. Date: Aug. 11, 2022

(54) INFORMATION PROCESSING DEVICE AND INFORMATION PROCESSING METHOD

(71) Applicant: NTT DOCOMO, INC., Tokyo (JP)

(72) Inventors: Syuusuke WATANABE, Tokyo (JP); Tadashige NAGAE, Tokyo (JP); Mitsuteru FUKUYAMA, Tokyo (JP); Masakazu HAMANO, Tokyo (JP); Takefumi YAMADA, Tokyo (JP); Takashi HARA, Tokyo (JP); Yuichiro SEGAWA, Tokyo (JP); Yasuhiro KITAMURA, Tokyo (JP)

(73) Assignee: NTT DOCOMO, INC., Tokyo (JP)

(21) Appl. No.: 17/438,104

(22) PCT Filed: Mar. 12, 2020
(86) PCT No.: PCT/JP2020/010791

§ 371 Date: Sep. 10, 2021

(30) Foreign Application Priority Data
Mar. 18, 2019 (JP) 2019-049808

(51) Int. Cl. G08G 5/04

(52) U.S. Cl. CPC G08G 5/045

(57) ABSTRACT

Wind information storage unit acquires and stores wind information indicating the windspeed and wind direction of wind that blows at a plurality of spots neighboring a facility targeted for examination. Wind predicting unit predicts the windspeed and wind direction at the facility targeted for examination, based on the wind information acquired by wind information storage unit. Flight instructing unit instructs, with regard to drone that flies around the facility and acquires examination data of the facility, flight that avoids colliding with the facility due to wind of the windspeed and wind direction predicted by wind predicting unit, before arrival of the wind. Flight instructing unit gives an instruction for collision avoidance in the case where a change in the windspeed predicted by wind predicting unit is greater than or equal to a threshold value.

### TECHNICAL FIELD

The present invention relates to a technology for supporting facility examination work that uses an aerial vehicle.

### BACKGROUND

As a technology for supporting facility examination work that uses an aerial vehicle, Japanese Patent Application No. JP 2018-21491A discloses a technology for acquiring rotation information indicating an orientation of the nacelle and a phase of the blades of a wind turbine targeted for inspection, and generating data of the flight route (inspection route) of an unmanned aircraft that acquires data for use in inspection, based on the rotation information.

### SUMMARY OF INVENTION

Acquisition of examination data (image data of facility, etc.) is performed as in the technology of Japanese Patent Application No. JP 2018-21491A, while flying an aerial vehicle such as a drone around a facility such as base station. The aerial vehicle also often flies close to the facility in order to acquire examination data, and there is a possibility of colliding with the facility when there is a strong wind blowing at that time. In view of this, an object of the present invention is to lessen the risk of an aerial vehicle buffeted by the wind colliding with a facility.

To achieve the stated object, the present invention provides an information processing device including an acquiring unit configured to acquire wind information indicating windspeed and wind direction at a plurality of spots neighboring a facility targeted for examination, a predicting unit configured to predict windspeed and wind direction at the facility based on the acquired wind information, and an instructing unit configured to instruct, with regard to an aerial vehicle that flies around the facility and acquires examination data of the facility, flight that avoids colliding with the facility due to wind of the predicted windspeed and wind direction, before arrival of the wind.

According to the present invention, the risk of an aerial vehicle buffeted by the wind colliding with a facility can be lessened.

### BRIEF DESCRIPTION OF THE DRAWINGS

FIG. 1 is a diagram showing an example of the overall configuration of a facility examination system according to an embodiment of the present invention.

FIG. 2 is a diagram showing an example of the hardware configuration of a server apparatus according to the present invention.

FIG. 3 is a diagram showing an example of the hardware configuration of a drone according to the present invention.

FIG. 4 is a diagram showing an example of the hardware configuration of a controller according to the present invention.

FIG. 5 is a diagram showing functional configurations realized by apparatuses according to the present invention.

FIG. 6 is a diagram showing an example of neighboring spot information according to the present invention.

FIG. 7 is a diagram showing an example of time series change in windspeed according to the present invention.

FIG. 8 is a diagram showing an example of time series change in current windspeed according to the present invention.

FIG. 9 is a diagram showing an example of instruction content that is displayed according to the present invention.

FIG. 10 is a diagram showing an example of operation procedures of apparatuses in avoidance processing according to the present invention.

FIG. 11 is a diagram showing an example of a timing table according to the present invention.

FIG. 12 is a diagram showing an example of a timing table in a modification according to the present invention.

FIG. 13 is a diagram showing an example of a timing table in a modification according to the present invention.

FIG. 14 is a diagram showing an example of a timing table in a modification according to the present invention.

FIG. 15 is a diagram showing an example of a timing table in a modification according to the present invention.

FIG. 16 is a diagram showing an example of a determination table according to the present invention.

FIG. 17 is a diagram showing another example of a determination table according to the present invention.

### DETAILED DESCRIPTION

### 1. Embodiments

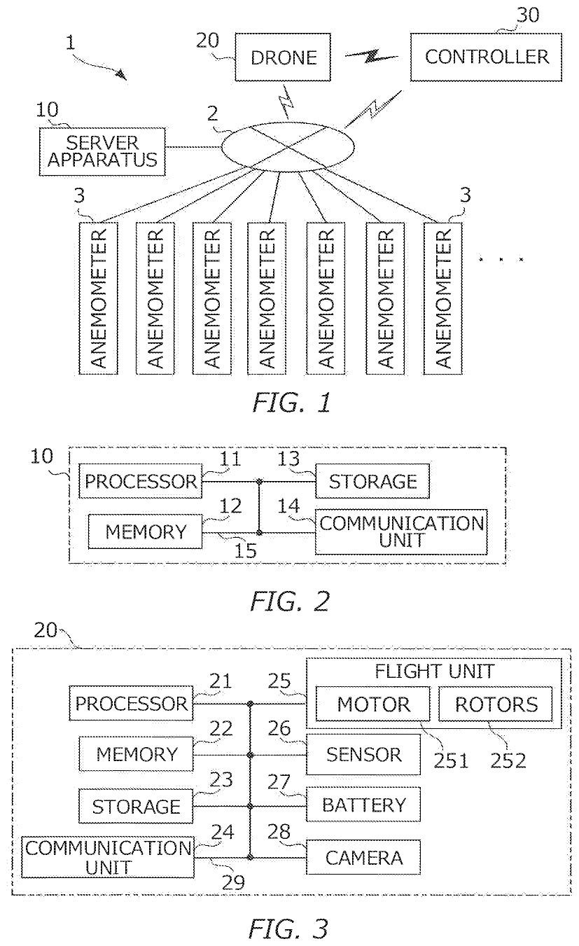

FIG. 1 shows an example of the overall configuration of facility examination system 1 according to an embodiment. Facility examination system 1 is a system that supports facility examination work that uses an aerial vehicle. The facilities targeted for examination are, for example, bridges, buildings and tunnels, and are periodically examined for the extent of deterioration, and undergo repair if necessary. The present embodiment describes the case where the facilities targeted for examination are mobile communication base stations.

The facilities targeted for examination deteriorate due to factors such as corrosion, separation, detachment, breakage, cracking, deformation, and discoloration. Examination of facilities is performed using examination data which is data for determining the extent of deterioration (deterioration level) due to corrosion and the like, and whether repair is needed. Examination data is, for example, measurement data of sensors such as infrared sensors, ultrasonic sensors, and millimeter wave sensors. In the present embodiment, image shooting data obtained by image shooting means (data showing still images or moving images) is used as examination data.

Determination of the level of deterioration and whether repair is needed based on examination data is primarily performed by an inspector. The inspector may determine the level of deterioration and the like by viewing displayed examination data, and may also determine the level of deterioration and the like after performing processing (image processing, etc.) for further analyzing examination data on a computer. Note that the agent of the determination need not be limited to a person, and the level of deterioration and the like may be determined by AI (Artificial Intelligence), for example.

Facility examination system 1 is provided with network 2, a plurality of anemometers 3, server apparatus 10, drone 20, and controller 30. Network 2 is a communication system including a mobile communication network, the internet and the like, and relays exchange of data between apparatuses that access the system. Network 2 is accessed by server apparatus 10 through wired communication (wireless communication is also possible), and by drone 20 and controller 30 through wireless communication.

In the present embodiment, drone 20 is a rotary-wing aerial vehicle that flies by rotating one or more rotary wings, and is provided with an image shooting function for shooting video of the surrounds. Drone 20 flies in accordance with operation of an operator, and acquires examination data (in the present embodiment, image shooting data of a facility). Drone 20 is deployed at a base such as the office of an inspection company. Proportional controller 30 is an apparatus that performs control in a proportional manner (proportional control), and is used by the operator in operating drone 20.

Anemometers 3 are machines that measure windspeed and wind direction at the places where anemometers 3 are located. Anemometers 3 perform measurement at a predetermined time interval, and transmit a measurement result every time measurement is performed, that is, wind information indicating the windspeed and wind direction and the measurement time and measurement position, to server apparatus 10. In the present embodiment, anemometers 3 are at least installed in respective base stations targeted for examination. Note that anemometers 3 may be installed not only in base stations but also in other spots.

Measurement of windspeed and wind direction is performed in order to avoid drone 20 colliding with facilities and buildings and the like around the facilities due to being affected by wind such as gusts or strong wind. Thus, shorter is desirable in terms of the time interval of measurement, and measurement is, for example, performed at intervals of around 1 to 5 seconds. Server apparatus 10 performs instruction processing and the like for avoiding drone 20 colliding with facilities and the like, based on the wind information transmitted thereto from a plurality of anemometers 3. Server apparatus 10 is an example of an “An information processing device” of the present invention.

The instruction for avoiding collision is an instruction to temporarily come to a stop during flight, to perform an emergency landing, or to move away from the facility, for example. In the present embodiment, server apparatus 10 transmits instruction data indicating the content of the instruction to controller 30. Proportional controller 30 outputs the instruction shown by the instruction data transmitted thereto through images, sounds or the like, and conveys the content of the instruction to the operator of drone 20. Collision of drone 20 with the facility or the like due to the effects of wind is avoided by the operator flying drone 20 in accordance with the instruction.

FIG. 2 shows an example of the hardware configuration of server apparatus 10. Server apparatus 10 may be physically constituted as a computer apparatus that includes processor 11, memory 12, storage 13, communication unit 14, and bus 15. Note that, in the following description, the term “apparatus” can be read as circuit, device, unit, and the like.

Also, “apparatuses” may include one or a plurality of apparatuses, and may also not include some apparatuses. Processor 11 performs overall control of the computer by operating an operating system, for example. Processor 11 may be constituted by a CPU (Central Processing Unit) that includes an interface with peripheral apparatuses, a control apparatus, a computational apparatus, and a register.

For example, a baseband signal processing unit and the like may be realized by processor 11. Also, processor 11 reads out programs (program code), software modules, data and the like to memory 12 from storage 13 and/or communication unit 14, and performs various types of processing in accordance with the read programs and the like. As for the programs, programs that cause the computer to execute at least some of operations described in the above-mentioned embodiment are used.

The various types of processing mentioned above are described as being executed by one processor 11, but may be executed simultaneously or sequentially by two or more processors 11. Processor 11 may be implemented by one or more chips. Note that programs may be transmitted from a network via a telecommunication line. Memory 12 is a computer-readable recording medium.

Memory 12 may, for example, be constituted by at least one of a ROM (Read Only Memory), an EPROM (Erasable Programmable ROM), an EEPROM (Electrically Erasable Programmable ROM), and a RAM (Random Access Memory). Memory 12 may be called a register, a cache, a main memory (main storage apparatus), and the like. Memory 12 is able to save programs (program code), software modules and the like that can be executed in order to implement a wireless communication method according to an embodiment of the present disclosure.

Storage 13 is a computer-readable recording medium, and may, for example, be constituted by at least one of an optical disc such as a CD-ROM (Compact Disc ROM), a hard disk drive, a flexible disk, a magneto-optical disc (e.g., compact disc, digital versatile disc, Blu-ray (registered trademark) disc), a smart card, a flash memory (e.g., card, stick, key drive), a floppy (registered trademark) disk, and a magnetic strip.

Storage 13 may also be referred to as an auxiliary storage apparatus. The above-mentioned storage medium may, for example, also be a database, server or other appropriate medium including memory 12 and/or storage 13. Communication unit 14 is hardware (transceiver device) for performing communication between computers via a wired network and/or a wireless network. Communication unit 14 is also referred to as a network device, a network controller, a network card, a communication module and the like, for example.

For example, the above-mentioned transceiver antenna, amplifier unit, transceiver unit, transmission path interface and the like may also be realized by communication unit 14. The transceiver unit may also be implemented by being physically or logically separated into a transmitting unit and a receiving unit. Also, apparatuses such as processor 11 and memory 12 are connected by bus 15 for communicating information. Bus 15 may be constituted using a single bus, and may also be constituted using different buses between different apparatuses.

FIG. 3 shows an example of the hardware configuration of drone 20. Drone 20 may be physically constituted as a computer apparatus that includes processor 21, memory 22, storage 23, communication unit 24, flight unit 25, sensor 26, battery 27, camera 28, and bus 29. Hardware such as processor 21 and the like of the same name as that in FIG. 2 is hardware of the same type as FIG. 2 but differing in performance, specification and the like.

Communication unit 24 has a function for performing communication with controller 30 (e.g., function for wireless communication using 2.4 GHz radio waves), in addition to communication with network 2. Flight unit 25 is an apparatus provided with a motor 251, rotors 252 and the like, and is for flying drone 20. Flight unit 25 is able to perform operations such as moving drone 20 in any direction and causing drone 20 to be stationary (hover) in the air.

Sensor 26 is an apparatus having a sensor group for acquiring information required in flight control. Sensor 26 is, for example, provided with a position sensor that measures the position (latitude and longitude) of drone 20, a direction sensor that measures the direction in which drone 20 is facing (direction in which the front of drone 20, which in drones is fixed, is facing), and an altitude sensor that measures the altitude of drone 20.

Also, sensor 26 is provided with a speed sensor that measures the speed of drone 20, and an IMU (Inertial Measurement Unit) that measures three-axial angular velocity and three-directional acceleration. Battery 27 is an apparatus that stores electric power and supplies power to the units of drone 20. Camera 28 is provided with an image sensor, optical components and the like, and shoots objects that are in the direction in which the lens is facing.

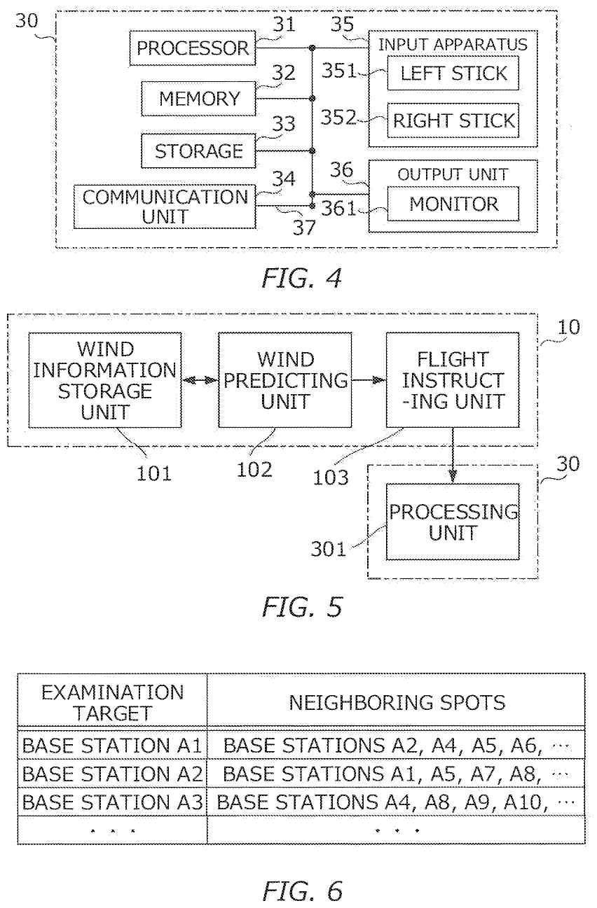

FIG. 4 shows an example of the hardware configuration of controller 30. Proportional controller 30 may be physically constituted as a computer apparatus that includes processor 31, memory 32, storage 33, communication unit 34, input unit 35, output unit 36, and bus 37. Hardware such as processor 31 and the like of the same name as that in FIG. 2 is hardware of the same type as FIG. 2 but differing in performance, specification and the like.

Input apparatus 35 is an input device (e.g., switch, button, sensor, etc.) that receives input from the outside. In particular, input unit 35 is provided with left stick 351 and right stick 352, and receives manual operation of the sticks as move operations in the front-back direction, up-down direction, left-right direction, and rotational direction of drone 20. Output unit 36 is an output device (e.g., monitor 361, speaker, LED (Light Emitting Diode) lamp, etc.) that implements output to the outside. Note that input unit 35 and output unit 36 may also be integrally constituted (e.g., monitor 361 is a touch screen).

Also, the above apparatuses may be configured to include hardware such as a microprocessor, a DSP (Digital Signal Processor), an ASIC (Application Specific Integrated Circuit), a PLD (Programmable Logic Device), and an FPGA (Field Programmable Gate Array). Also, some or all of the functional blocks of the above apparatuses may be realized by the above hardware. For example, processor 11 may be implemented using at least one of the above hardware.

The functions of the apparatuses with which facility examination system 1 is provided are realized by respective processors performing computations and performing control of communication by respective communication unites and control of reading out and/or writing of data in memory and storage, by causing predetermined software (programs) to be loaded on hardware such as the processors and memories.

FIG. 5 shows a functional configuration that is realized by apparatuses. Server apparatus 10 is provided with wind information storage unit 101, wind predicting unit 102, and flight instructing unit 103. Proportional controller 30 is provided with instructed processing execution unit 301. Wind information storage unit 101 acquires and stores wind information indicating the windspeed and wind direction of wind blowing at a plurality of spots neighboring the facility targeted for examination. Wind information storage unit 101 is an example of an “acquiring unit” of the present invention.

Wind information storage unit 101 acquires and stores all the wind information transmitted to server apparatus 10 from a plurality of anemometers 3. Windspeed is represented in meters per second, wind direction is represented by an angle formed in the case where due north is zero degrees (due east, south and west will respectively be 90, 180 and 270 degrees). As described above, a plurality of anemometers 3 are at least installed in respective base stations. Base stations are dispersed all over the country such that cells (range of radio waves) centering on respective base stations overlap, and thus a base station is always nearby other base stations.

Thus, wind information storage unit 101 is able to acquire wind information from a plurality of anemometers 3 as wind information at a plurality of spots neighboring the facility (base station) targeted for examination. Note that for any one base station targeted for examination, the plurality of neighboring spots includes not only the spots of base stations whose cell overlaps with the one base station but also the spots of base stations whose cell does not overlap but where there is wind showing tendencies of the wind blowing at the one base station.

The range of wind that shows tendencies of the wind blowing at the one base station changes depending not only on the distance from the base station but also on surrounding geographical features. For example, the range broadens in a plain where there is nothing to block the wind, and the range narrows in mountainous regions and forested regions where there are many things that block the wind. Wind information storage unit 101 stores in advance neighboring spot information indicating the relationship between the base station targeted for examination and a plurality of neighboring spots (base stations of neighboring spots).

FIG. 6 shows an example of neighboring spot information. In the neighboring spot information shown in FIG. 6, “base stations A2, A4, A5, A6 . . . ” are associated as neighboring spots in the case where the examination target is “base station A1”, for example. In the example in FIG. 6, neighboring spots are also associated with base stations A2, A3 and the like. In the present embodiment, wind information storage unit 101 stores, as one set, the wind information of the base station targeted for examination and the wind information of spots neighboring the base station, out of all the acquired wind information.

Wind predicting unit 102 predicts the windspeed and wind direction at the facility targeted for examination, based on the wind information acquired by wind information storage unit 101. Wind predicting unit 102 is an example of a “predicting unit” of the present invention. Wind predicting unit 102, first, as a preparatory stage of prediction, extracts a set consisting of wind information measured at a given time at base station A1, for example, out of stored wind information, and wind information measured at the same time at a spot (hereinafter, “upwind spot”) located upwind of base station A1 (i.e., wind information measured at an upwind spot of base station Al), among spots neighboring base station A1.

The wind information measured at the upwind spot of base station A1, naturally, changes depending on wind direction. In the case where the wind directions at the base stations are in common, for example, wind predicting unit 102 extracts wind information measured at a base station located in the opposite direction to the common wind direction seen from base station Al, that is, in the upwind direction. Even if there is not a base station located exactly in the upwind direction, wind predicting unit 102 extracts wind information measured at a base station that deviates least from the upwind direction.

Also, in the case where there is variability in the wind directions at the base stations, wind predicting unit 102 computes an average value of the values of the wind directions, and extracts wind information measured upwind with the opposite direction to the direction indicated by the computed average value taken as the upwind direction seen from base station A1. Wind predicting unit 102 extracts a set of wind information at each measurement time, and compares the time series change in windspeed measured at base station A1 with time series change in windspeed measured at the upwind spot.

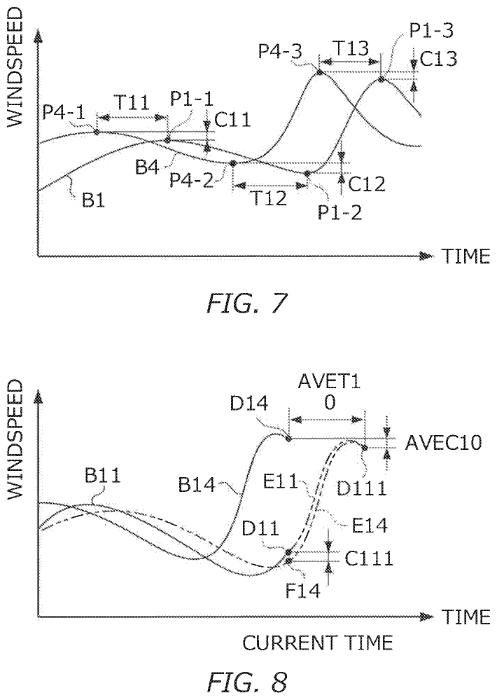

FIG. 7 shows an example of the time series change in windspeed. In the example in FIG. 7, time series change B1 in windspeed measured at base station A1 and time series change B4 in windspeed measured at base station A4 which is the upwind spot of base station A1 are shown in a graph whose horizontal and vertical axes respectively show time and windspeed. Peaks P1-1, P1-2 and P1-3 appear in time series change Bl, and peaks P4-1, P4-2 and P4-3 appear in time series change B4.

The peaks in time series change are the windspeeds and times at which the slope of time series change switches between positive and negative (there are upward peaks where the wind becomes stronger and then dies down, and downward peaks where the wind dies down and then becomes stronger). It is conceivable that when the wind at which peaks are observed at base station A4 reaches base station A1, peaks will be similarly observed. In view of this, wind predicting unit 102 computes the time difference between the peaks of time series change B4 and the peaks of time series change Bl, in order to predict the time it will take for the wind observed at base station A4 to reach base station Al.

Also, wind predicting unit 102 computes the windspeed difference between the peaks of time series change B4 and the peaks of time series change B 1, in order to predict how much the windspeed of wind observed at base station A4 will change before reaching base station Al. In the example in FIG. 7, wind predicting unit 102 computes time difference T11 and windspeed difference C11 between peaks P4-1 and P1-1, and computes time difference T12 and windspeed difference C12 between peaks P4-2 and P1-2.

Also, wind predicting unit 102 computes time difference T13 and windspeed difference C13 between peaks P4-3 and P1-3. Note that, in the example in FIG. 7, the difference between peak P4-1 and peak P1-1 that appears next after peak P4-1 is computed on the graph, but in the case where there is a long distance between base stations, for example, a plurality of peaks may appear before the wind of the observed peak reaches a downwind base station.

In this case, wind predicting unit 102 roughly computes the time it will take for the wind to reach the downwind base station from the distance and windspeed between base stations, and computes the respective differences at the pair of peaks (upward peaks or downward peaks) at which a time difference closest to the roughly computed time is computed. Wind predicting unit 102 computes the differences for all wind information measured at times at which base station A4 is located upwind of base station Al, and computes an average value of the computed differences.

Wind predicting unit 102 also computes the time difference and windspeed difference in a similar manner to the above for other wind directions. Wind predicting unit 102 also computes the time difference and windspeed difference at each upwind spot in a similar manner to the above for base stations targeted for examination other than base station Al. Wind predicting unit 102 performs the operations described to this point in advance as a preparatory stage of prediction. Wind predicting unit 102 performs actual prediction when drone 20 flies and acquires examination data.

When performing actual prediction, wind predicting unit 102 compares the time series change in current windspeed at the base station targeted for examination with the time series change in windspeed measured at the current upwind spot, based on wind information that is acquired in real time by wind information storage unit 101.

FIG. 8 shows an example of time series change in current windspeed. In the example in FIG. 8, time series change B11 in windspeed measured at base station A1 and time series change B14 in windspeed measured at base station A4 which is the upwind spot of base station A1 similarly to FIG. 7 are shown.

In FIG. 8, measurement result Dll of base station A1 and measurement result D14 in base station A4 at the current time are shown. There is a high possibility that wind of the windspeed indicated by measurement result D14 will also be measured at base station A1 when average value aveT10 of the time difference mentioned in the description of FIG. 7 passes. Also, there is a high possibility that wind of the windspeed indicated by measurement result D14 will be measured at base station A1 after having changed by average value aveC10 of the windspeed difference mentioned in the description of FIG. 7.

In the example in FIG. 8, predicted measurement result D111 is shown at the position at which the time of average value aveT10 has passed from measurement result D14 and the windspeed has dropped by average value aveC10. Also, in the example in FIG. 8, virtual change E14, which is virtual time series change B14 in the case where the position of measurement result D14 is moved to predicted measurement result D111, is shown. Supposing that measurement result F14 of virtual change E14 at the current time coincides with actual measurement result D11 of base station A1, wind predicting unit 102 will compute virtual change E14 as the predicted time series change at base station Al.

As shown in FIG. 8, however, measurement results F14 and Dll do not necessarily coincide. In view of this, wind predicting unit 102 computes difference C111 between measurement result F14 at the current time and measurement result D11. Wind predicting unit 102 computes, as the predicted time series change at base station A1, time series change E11 in which the difference with virtual change E14 gradually becomes smaller from C111 and will be zero upon reaching predicted measurement result D111.

To this point, wind predicting unit 102 performed prediction in a situation where the upwind spot of base station A1 does not change from base station A4. In the case where the upwind spot of base station A1 changes from base station A4 to another base station, wind predicting unit 102 performs prediction that is based on the time series change of the pre-change upwind spot until the time at which it is predicted that the wind measured at the upwind spot immediately before the upwind spot changed reaches base station A1, for example.

When the predicted time arrives, wind predicting unit 102 performs comparison of the time series change shown in FIG. 8 for the post-change upwind spot, and predicts the time series change in windspeed at base station Al, using the time difference and windspeed difference that are computed as described with FIG. 7 for the post-change upwind spot. Wind predicting unit 102 supplies an equation indicating the time series change computed as above to flight instructing unit 103 as the prediction result. Note that the method of predicting windspeed and wind direction mentioned above is an example, and other known prediction technology may be used.

Flight instructing unit 103 instructs, with regard to drone 20 that flies around a facility and acquires examination data of the facility, flight that avoids colliding with the facility due to wind of the windspeed and wind direction predicted by wind predicting unit 102, before arrival of the wind. Flight instructing unit 103 is an example of an “instructing unit ” of the present invention. In the present embodiment, flight instructing unit 103 gives an instruction (hereinafter “avoidance instruction”) for the aforementioned collision avoidance in the case where the change in windspeed predicted by wind predicting unit 102 is at or above a threshold value.

Flight instructing unit 103 determines that a gust of wind will soon reach the facility targeted for examination, in the case where the slope from the current time until when a predetermined time period (e.g., several seconds) passes is at or above a threshold value in the time series change supplied from wind predicting unit 102. Upon determining that a gust of wind will arrive, flight instructing unit 103 generates instruction data that instructs to hover after moving drone 20 at least a predetermined distance away from the facility or the like, for example.

Flight instructing unit 103 transmits the generated instruction data to controller 30. Instructed processing execution unit 301 of controller 30 performs processing corresponding to the instruction shown by the transmitted instruction data (hereinafter “instructed processing”). In the present embodiment, instructed processing execution unit 301 performs, as instructed processing, processing for conveying the instruction content shown by the instruction data to the operator by displaying the instruction content on monitor 361 of controller 30.

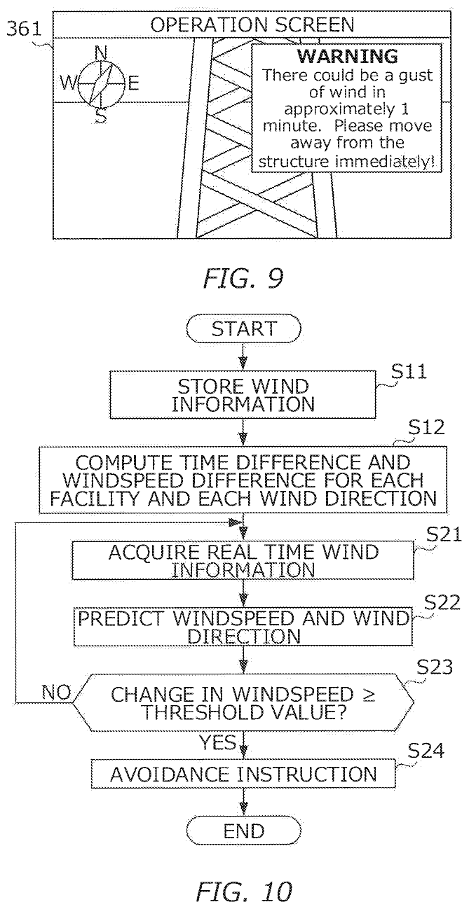

FIG. 9 shows an example of instruction content that is displayed. In the example in FIG. 9, instructed processing execution unit 301 displays text stating “There could be a gust of wind in approximately 1 minute. Please move away from the structure immediately!” on the operation screen of controller 30. Due to the operator who has viewed the displayed text operating controller 30 to move drone 20 away from antenna facility or the like of the base station, collision with antenna facility or the like can be avoided, even if drone 20 is buffeted by the gust that arrives and is blown around.

In the example in FIG. 9, flight instructing unit 103 gives the avoidance instruction together with sending notification of the time at which wind of the windspeed and wind direction predicted by wind predicting unit 102 will arrive to the operator of drone 20. Flight instructing unit 103 sends, as the arrival time of the wind, notification of the time at which the change in windspeed becomes greater than or equal to a threshold value in the time series change supplied as the prediction result. Due to the arrival time of the wind thus being notified, the operator knows exactly by when he or she has to perform an avoidance operation, and thus the operator can calmly operate drone 20, compared with the case where there is no notification of the arrival time.

Server apparatus 10 predicts the windspeed and wind direction at the facility targeted for examination, based on the above configuration, and performs instruction processing for instructing the avoidance by drone 20 described above. FIG. 10 shows an example of operation procedures of apparatuses in the instruction processing. The operation procedures in FIG. 10 are started, triggered by facility examination system 1 starting to operate, for example. First, server apparatus 10 (wind information storage unit 101) acquires and stores wind information indicating the windspeed and wind direction of wind blowing at a plurality of spots neighboring the facility targeted for examination (step S11).

Next, server apparatus 10 (wind predicting unit 102) computes the time difference and windspeed difference at the upwind spot mentioned in the description of FIG. 7, for every facility targeted for examination and every wind direction (step S12). The operation of step Sll is continuously performed during operation of facility examination system 1, and the operation of step S12 is performed at a predetermined time interval (every day, etc.), for example. Subsequently, server apparatus 10 (wind information storage unit 101) acquires real time wind information of facilities including the facility targeted for examination (step S21).

Next, server apparatus 10 (wind predicting unit 102) predicts the windspeed and wind direction at the facility targeted for examination, based on the differences computed in step S12 and the wind information acquired in step S21 (step S22). Subsequently, server apparatus 10 (flight instructing unit 103) determines whether the change in predicted windspeed is at or above a threshold value (step S23). Server apparatus 10 (flight instructing unit 103) performs operations after returning to step S21 if it is determined that the change in windspeed is not at or above the threshold value (NO), and gives an avoidance instruction (step S24) and ends the operation procedures in FIG. 10 if it is determined that the change in windspeed is at or above the threshold value (YES).

In the present embodiment, the arrival of wind is predicted before the wind reaches the facility targeted for examination, based on wind information indicating the windspeed and wind direction measured at a plurality of spots neighboring the facility targeted for examination as described above, and an instruction for avoiding collision is given if necessary. The possibility of an aerial vehicle such as drone 20 buffeted by the wind (in the present embodiment, a gust) colliding with a facility can be lessened, compared with the case where prediction of wind is not performed.

### 2. Modifications

The above-mentioned embodiment is merely an example of implementation of the present invention, and may be modified as follows. Also, the embodiment and modifications may be respectively combined if necessary. When combining the embodiment and modifications, the modifications may be implemented in ranked order (ranking for determining which modification to prioritize if conflicting events occur when implementing the modifications).

Also, as a specific combining method, modifications that use different parameters in order to derive a common index (e.g., level of deterioration) may be combined, and the common index may be derived using the parameters together, for example. Also, one index or the like may be derived by integrating individually derived indices in accordance with a rule of some sort. Also, when calculating a common index, the parameters that are used may each be weighted differently.

2-1. Avoidance Instruction at time of Strong Wind

In the embodiment, flight instructing unit 103 gives an avoidance instruction in the case where a gust of wind is predicted, but may give an avoidance instruction in the case where strong wind is predicted, for example, other than a gust. Specifically, flight instructing unit 103 gives an avoidance instruction in the case where the windspeed predicted by wind predicting unit 102 is at or above a threshold value. In this modification, the possibility of an aerial vehicle such as drone 20 buffeted by strong wind colliding with a facility can be lessened, compared with the case where prediction of wind is not performed.

2-2. Notification Content of Avoidance Instruction

In the embodiment, flight instructing unit 103 sends notification of the arrival time of a gust of wind in the avoidance instruction, but, other than this, may also send notification of the predicted windspeed or wind direction of a gust or strong wind, or both the windspeed and wind direction, for example. An operation for avoiding collision can be more appropriately performed by the operator when the notification content is more detailed.

2-3. Control of Drone

In the embodiment, the flight of drone 20 and acquisition of examination data are controlled by operation of controller 30, but flight and acquisition of examination data may be controlled autonomously by transmitting an instruction of the flight path, flying speed, flight time, image shooting timing and the like to drone 20 from a personal computer or the like, for example.

2-4. Target of Avoidance Instruction

Flight instructing unit 103 may give an avoidance instruction that differs from the embodiment. Flight instructing unit 103 may, for example, transmit instruction data indicating an avoidance instruction to another terminal (e.g., smartphone or laptop PC, etc.) of the user, instead of controller 30. Also, in the case where the aforementioned autonomous control of drone 20 is performed, flight instructing unit 103 may transmit instruction data that instructs flight control for avoiding collision directly to drone 20.

Specifically, flight instructing unit 103 sends a request for notification of current position to drone 20, computes a direction in which to move away from the facility upon notification of current position being received, and transmits instruction data that instructs to hover after moving a predetermined distance in the computed direction to drone 20, for example. By thus giving the avoidance instruction directly to drone 20, collision can be avoided without being dependent on the skills of the operator.

2-5. Instruction Timing: Drone Performance

Flight instructing unit 103 may change the timing at which the avoidance instruction is given according to the situation. In this modification, flight instructing unit 103 gives the avoidance instruction at an increasingly earlier timing before arrival of the predicted wind as the performance of drone 20 decreases. In this modification, it is assumed that a plurality of drones 20 are used in acquisition of examination data, and performance information indicating the performance of each drone 20 is registered and stored in server apparatus 10 in advance.

The provision of specific functions is included in the performance information as performance effective in order to reduce the risk of collision with a facility due to wind. The specific functions are, for example, a collision avoidance function that uses an object sensor, and an automatic hovering function for maintaining a position that is measured by GPS (Global Positioning System). Flight instructing unit 103 stores a timing table in which provision of specific functions and performance levels are associated with times that elapse until the avoidance instruction is given after determining that a specific type of wind (gust or strong wind, etc.) will reach the facility targeted for examination.

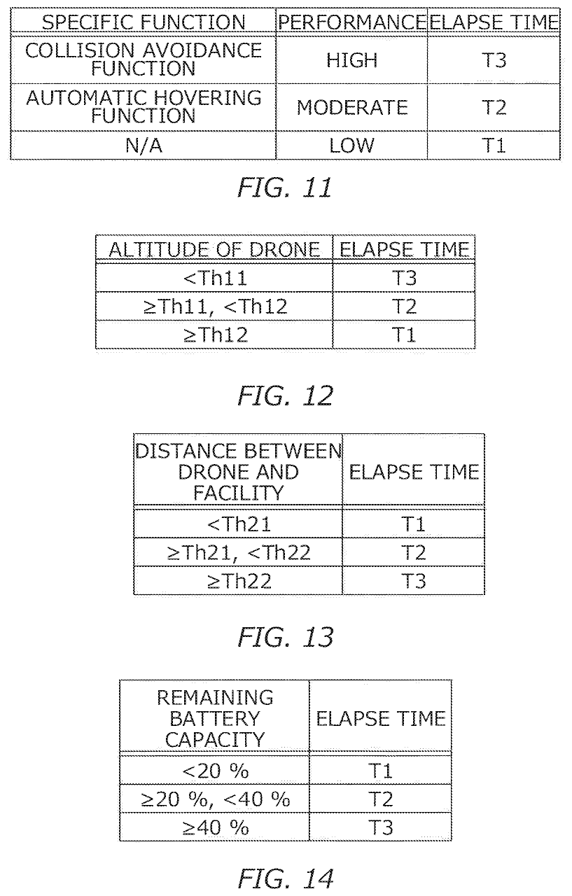

FIG. 11 shows an example of the timing table. In the example in FIG. 11, specific functions “collision avoidance function”, “automatic hovering function” and “N/A” and performance levels “high”, “moderate” and “low” are associated with elapse times “T3”, “T2” and “Ti” (T3>T2>T1). In the case of giving the avoidance instruction when the change in windspeed predicted for the facility targeted for examination is greater than or equal to a threshold value as in the embodiment, for example, flight instructing unit 103 reads out the performance information of drone 20 that acquires the examination data of that facility.

In the case where the read performance information indicates that a specific function is not provided, flight instructing unit 103 determines that performance is “low”, and gives the avoidance instruction at the timing at which time Ti has elapsed after the change in windspeed becomes greater than or equal to the threshold value. In the case where the read performance information indicates that the automatic hovering function is provided, flight instructing unit 103 determines that performance is “moderate”, and gives the avoidance instruction at the timing at which time T2 has elapsed after the change in windspeed becomes greater than or equal to the threshold value.

In the case where the read performance information indicates that the collision avoidance function is provided, flight instructing unit 103 determines that performance is “high”, and gives the avoidance instruction at the timing at which time T3 has elapsed after the change in windspeed becomes greater than or equal to the threshold value. Since T3>T2>T1, the avoidance instruction will be given at an increasingly earlier timing than the arrival of the predicted wind as the performance of drone 20 decreases. In this modification, the task of acquiring examination data can be carried out smoothly, while avoiding a low performance aerial vehicle, in particular, colliding with the facility, compared with the case where the timing of the avoidance instruction is fixed.

2-6. Instruction Timing: Altitude

In this modification, flight instructing unit 103 gives the avoidance instruction at an increasingly earlier timing than the arrival of the predicted wind as the altitude of drone 20 increases. In this modification, it is assumed that drone 20 that acquires examination data transmits altitude information indicating the altitude of drone 20 to server apparatus 10 periodically (e.g., every second).

Flight instructing unit 103 stores a timing table in which altitudes of drone 20 are associated with elapse times until the avoidance instruction described with FIG. 11. FIG. 12 shows an example of the timing table of this modification. In the example in FIG. 12, altitudes of drone 20 “<Th11”, “≥Th11, <Th12” and “≥Th12” are associated with elapse times “T3”, “T2”, and “T1 ” (T3>T2>T1).

In the case of giving the avoidance instruction when the change in predicted windspeed is greater than or equal to a threshold value, for example, flight instructing unit 103 reads out the threshold value associated in the timing table with the altitude information transmitted thereto from drone 20 that acquires examination data of the facility. Flight instructing unit 103 gives the avoidance instruction at the timing at which time Ti has elapsed after the change in windspeed becomes greater than or equal to the threshold value in the case where the altitude information indicates the altitude “≥Th12”, and gives the avoidance instruction at the timing at which time T3 has elapsed after the change in windspeed becomes greater than or equal to the threshold value in the case where the altitude information indicates the altitude “<Th11”

Since T3>T2>T1, the avoidance instruction will be given at an increasingly earlier timing than the arrival of the predicted wind as the altitude of drone 20 increases. Damage caused when drone 20 is downed (injury to people and damage to structures, damage to drone 20 itself, etc.) increases as the flight altitude of drone 20 increases. In this modification, the task of acquiring examination data can be carried out smoothly while preventing more extensive damage caused by a fall, compared with the case where the timing of the avoidance instruction is fixed.

2-7. Instruction Timing: Distance from Facility

In this modification, flight instructing unit 103 gives the avoidance instruction at an increasingly earlier timing than the arrival of the predicted wind as the distance to the facility when drone 20 acquires examination data becomes shorter. In this modification, it is assumed that drone 20 that acquires examination data is provided with a distance sensor, and transmits distance information indicating the distance to the facility targeted for examination to server apparatus 10 periodically (e.g., every second).

Flight instructing unit 103 stores a timing table in which distances between drone 20 and the facility are associated with elapse times until the avoidance instruction described with FIG. 11. FIG. 13 shows an example of the timing table of this modification. In the example in FIG. 13, distances between drone 20 and the facility “<Th21”, “≥Th21, <Th22” and “≥Th22” are associated with elapse times “T1”, “T2” and “T3” (T3>T2>T1).

In the case of giving the avoidance instruction when the change in predicted windspeed is greater than or equal to a threshold value, for example, flight instructing unit 103 reads out the threshold value associated in the timing table with the distance between drone 20 and the facility shown in the distance information transmitted thereto from drone 20 that acquires examination data of the facility. Flight instructing unit 103 gives the avoidance instruction at the timing at which time T3 has elapsed after the change in windspeed becomes greater than or equal to the threshold value in the case where distance information indicates the distance “≥Th22”, and gives the avoidance instruction at the timing at which time Ti has elapsed after the change in windspeed becomes greater than or equal to the threshold value in the case where distance information indicates the distance “<Th21”.

Since T3>T2>T1, the avoidance instruction will be given at an increasingly earlier timing than the arrival of the predicted wind as the distance between drone 20 and the facility decreases. Drone 20 buffeted by the wind becomes more likely to collide with the facility as the distance between drone 20 and the facility decreases. In this modification, by giving the avoidance instruction at the timing shown in FIG. 13, the task of acquiring examination data can be carried out smoothly, while avoiding an aerial vehicle that is close to the facility, in particular, colliding with the facility, compared with the case where the timing of the avoidance instruction is fixed.

Note that the method of measuring the distance between drone 20 and the facility is not limited to a distance sensor. For example, as long as drone 20 has a function for measuring position information with sufficient accuracy, flight instructing unit 103 may compute the distance between drone 20 and the facility using measured position information and position data indicating the position of the facility. Also, flight instructing unit 103 may compute the distance between drone 20 and the facility from video of the facility that is shot, in the case where the size of the facility is known.

2-8. Instruction Timing: Remaining Battery Capacity

In this modification, flight instructing unit 103 gives the avoidance instruction at an increasingly earlier timing than the arrival of the predicted wind as the remaining battery capacity of drone 20 decreases. In this modification, it is assumed that drone 20 that acquires examination data is provided with a sensor for measuring the remaining battery capacity, and transmits remaining capacity information indicating the remaining battery capacity to server apparatus 10 periodically (e.g., every second).

Flight instructing unit 103 stores a timing table in which remaining battery capacities of drone 20 are associated with elapse times until the avoidance instruction described with FIG. 11. FIG. 14 shows an example of the timing table of this modification. In the example in FIG. 14, remaining battery capacities “<20%”, “≥20%, <40%” and “≥40%” are associated with elapse times “T1”, “T2” and “T3” (T3>T2>T1).

In the case of giving the avoidance instruction when the change in predicted windspeed is greater than or equal to a threshold value, for example, flight instructing unit 103 reads out the threshold value associated in the timing table with the remaining battery capacity indicated by the remaining capacity information transmitted thereto from drone 20 that acquires the examination data of the facility. Flight instructing unit 103 gives the avoidance instruction at the timing at which time T3 has elapsed after the change in windspeed becomes greater than or equal to the threshold value in the case where the remaining capacity information indicates remaining battery capacity of “>40%”, and gives the avoidance instruction at the timing at which time T1 has elapsed after the change in windspeed becomes greater than or equal to the threshold value in the case where the remaining capacity information indicates remaining battery capacity of “<20%”.

Since T3>T2>T1, the avoidance instruction will be given at an increasingly earlier timing than the arrival of the predicted wind as the remaining battery capacity of drone 20 decreases. A shortage of power required for landing in flight for collision avoidance is more likely to occur as the remaining battery capacity of drone 20 decreases. In this modification, by giving the avoidance instruction at the timing shown in FIG. 14, the task of acquiring examination data can be carried out smoothly, while providing a sufficient time margin to carry out preparation for landing with an aerial vehicle with little remaining battery capacity, in particular.

2-9. Instruction Timing: Size of Site

In this modification, flight instructing unit 103 gives the avoidance instruction at an increasingly earlier timing than the arrival of the predicted wind as the site where the facility targeted for examination is provided decreases in size. In this modification, it is assumed that flight instructing unit 103 stores area information indicating the area of the site where each facility provided.

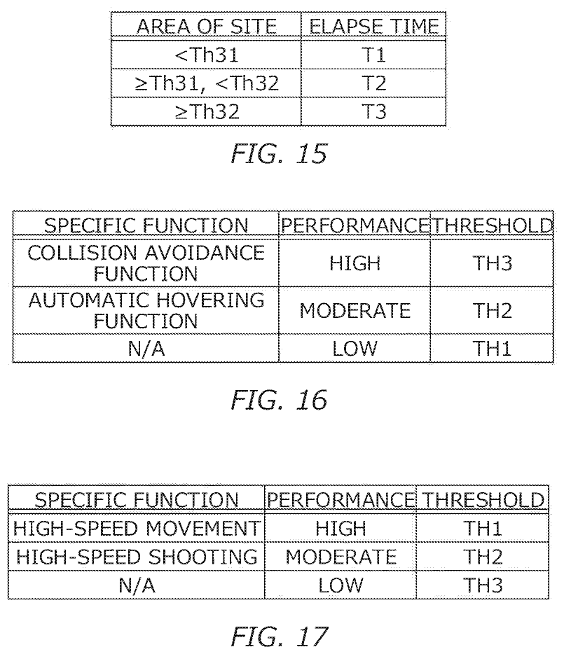

Flight instructing unit 103 stores a timing table in which areas of the site where the facility is provided are associated with elapse times until the avoidance instruction described with FIG. 11. FIG. 15 shows an example of the timing table of this modification. In the example in FIG. 15, the areas of the site “<Th31”, “≥Th31, <Th32” and “≥Th32” are associated with elapse times “T1”, “T2” and “T3” (T3>T2>T1).

In the case of giving the avoidance instruction when the change in predicted windspeed is greater than or equal to a threshold value, for example, flight instructing unit 103 refers to the area of the site where the facility targeted for examination is provided from the stored area information, and reads out the threshold value associated in the timing table with area of the site referred to. Flight instructing unit 103 gives the avoidance instruction at the timing at which time T3 has elapsed after the change in windspeed becomes greater than or equal to the threshold value in the case where the area of the site is “≥32Th”, and gives the avoidance instruction at the timing at which time Ti has elapsed after the change in windspeed becomes greater than or equal to the threshold value in the case where the area of the site is “>31Th”.

Since T3>T2>T1, the avoidance instruction will be given at an increasingly earlier timing than the arrival of the predicted wind as the site where the facility targeted for examination is provided decreases in size. In this modification, by giving the avoidance instruction at the timing shown in FIG. 15, the task of acquiring examination data can be carried out smoothly, while lessening the possibility of drone 20 falling outside the facility in the chance event that drone 20 buffeted by the wind is downed, compared with the case where the timing of the avoidance instruction is fixed.

2-10. Prediction Method

In the above examples, wind predicting unit 102 predicts windspeed and wind direction based on wind information measured at the facility targeted for examination and wind information at an upwind spot, but may perform prediction based also on other wind information. For example, the wind around an upwind spot but not at the upwind spot is thought to affect the wind that reaches the facility targeted for examination.

In view of this, wind predicting unit 102 may predict windspeed and wind direction based also on wind information that is measured around an upwind spot in addition to the wind information measured at the facility targeted for examination and the wind information of the upwind spot. In the case where there is variability in the time difference and windspeed difference at the upwind spot described with FIG. 7, for example, wind predicting unit 102 learns the correlation relationship between this variability and the windspeed and wind direction indicated by the wind information measured around the upwind spot.

A known machine learning technique such as a neural network, deep learning, cluster analysis or a Bayesian network, AI (Artificial Intelligence) technology or the like need only be used for wind predicting unit 102. Also, wind predicting unit 102 may perform prediction by further extending the range of wind information that is used in learning, and working out the correlation relationship between wind information measured at the facility targeted for examination and all wind information measured at facilities other than the examination target.

2-11. Consideration of Weather Information

In the above examples, wind predicting unit 102 predicts windspeed and wind direction using only the windspeed and wind direction measured by anemometers 3, but may perform prediction also using other information. In this modification, wind information storage unit 101 acquires weather information of a region that includes the facility targeted for examination, in addition to the wind information at a plurality of spots neighboring the facility (base station) targeted for examination.

Wind predicting unit 102 performs prediction through weighting the windspeed indicated by the wind information acquired by wind information storage unit 101 with regard to a spot (hereinafter, “upwind spot”) shown as being located upwind by the weather information acquired by wind information storage unit 101. The upwind spot indicated by the wind directions measured by anemometers 3 and the upwind spot indicated by the weather information may coincide with each other or may differ from each other.

The wind directions measured by anemometer 3 are measured at a shorter time interval compared with the weather information, and show local wind directions. Thus, when the wind swirls around anemometers 3, for example, the wind direction changes greatly, and a direction that is not suitable as upwind may be used as the upwind direction. On the other hand, the wind direction indicated by weather information shows the tendency of the flow of air over a wider range, and thus tends not to be affected by local changes in wind.

In view of this, by wind predicting unit 102 performing prediction through weighting the windspeed of the upwind spot indicated by the weather information, while using both the upwind spots indicated by the wind direction measured by anemometers 3 and the upwind spot indicated by the weather information, local changes in wind around anemometers 3 can be made less likely to exert an influence, compared with the case where the weather information is not taken into consideration. As a result, the accuracy of prediction by wind predicting unit 102 can be enhanced, compared with the case where the weather information is not taken into consideration.

2-12. Determination of Gusts

Flight instructing unit 103 may vary the threshold value used in determining gusts of wind described in the embodiment. For example, flight instructing unit 103 uses a value that depends on the performance of drone 20 as the threshold value. Flight instructing unit 103 stores a determination table in which the provision of specific functions and levels of performance are stored in association with threshold values that are used in determination of gusts.

FIG. 16 shows an example of the determination table. In the example in FIG. 16, specific functions “collision avoidance function”, “automatic hovering function” and “N/A” and performance levels “high”, “moderate” and “low” are associated with threshold values “Th3”, “Th2” and “Th1” (Th3>Th2>Th1). In the case where performance information is registered in advance as mentioned in the example in FIG. 11, flight instructing unit 103 reads out the performance information of drone 20 that acquires the examination data of the facility targeted for examination.

Flight instructing unit 103 specifies the performance associated with the read performance information, and performs determination of a gust of wind using the threshold value associated with the specified performance. Since Th3>Th2>Th1, flight instructing unit 103 determines the occurrence of a gust using a smaller value as the threshold value as the performance of drone 20 decreases, and gives the avoidance instruction even with a weak gust that causes a small change in windspeed.

Conversely, flight instructing unit 103 determines the occurrence of a gust using a larger value as the threshold value as the performance of drone 20 increases, and does not give the avoidance instruction if not a strong gust that causes a large change in windspeed. According to the example in FIG. 16, the task of acquiring examination data can be carried out smoothly by a high performance aerial vehicle, in particular, while lessening the possibility of a low performance aerial vehicle, in particular, being buffeted by a gust of wind and downed, compared with the case where the threshold value used in determination of a gust is fixed.

FIG. 17 shows another example of a determination table. In the example in FIG. 17, specific functions “high-speed movement”, “high-speed image shooting” and “N/A”, and performance levels “high”, “moderate” and “low” are associated with threshold values “Th1”, “Th2” and “Th3” (Th3>Th2>Th1). Flight instructing unit 103 performs determination of a gust similarly to the example in FIG. 16, using the determination table shown in FIG. 17, and gives the avoidance instruction.

In the example in FIG. 17, flight instructing unit 103 determines the occurrence of a gust using a larger value as the threshold value as the performance of drone 20 decreases, and does not give the avoidance instruction if not a strong wind that causes a large change in windspeed. Conversely, flight instructing unit 103 determines the occurrence of a gust using a smaller value as the threshold value as the performance of drone 20 increases, and gives the avoidance instruction even if a weak gust that causes a small change in windspeed.

In the case of the example in FIG. 17, making up for a delay caused by the task of acquiring examination data being interrupted due to avoiding a gust becomes easier as the performance of drone 20 increases. Thus, a configuration can be adopted that results in work delays being less likely to occur by prioritizing smoothly carrying out the task of acquiring examination data in the case where the performance of drone 20 is low, while avoiding the risk of chance collisions by giving the avoidance instruction even with weak gusts in the case where the performance of drone 20 is high.

Note that, besides the performance of drone 20, flight instructing unit 103 may use, as the threshold value, a value that depends on at least one of the altitude of drone 20, the distance to the facility at the time of drone 20 acquiring examination data, the remaining battery capacity of drone 20, and the size of the site where the facility targeted for examination is provided described in the above examples.

In all cases, by increasing the threshold value as it becomes more unlikely that collision caused by a gust will occur, the task of acquiring examination data can be carried out smoothly, while lessening the possibility of the aerial vehicle being buffeted by a gust of wind and downed. Also, a configuration can be adopted in which, by increasing the threshold value as it becomes easier to make up for delays caused by the task of acquiring examination data being interrupted, delays in the task of acquiring examination data become less likely to occur, while avoiding the risk of chance collisions of the aerial vehicle.

2-13. Determination of Strong Wind

When performing strong wind determination, flight instructing unit 103 may vary the threshold value similarly to the examples described with FIGS. 16 and 17. In other words, when giving the avoidance instruction in the case where the windspeed predicted by wind predicting unit 102 is at or above a threshold value, flight instructing unit 103 may use, as the threshold value, a value that depends on at least one of the performance of drone 20, the altitude of drone 20, the distance to the facility at the time of drone 20 acquiring examination data, the remaining battery capacity of drone 20, and the size of the site where the facility targeted for examination is provided.

In this modification, similarly to the above modification, by increasing the threshold value as it becomes less likely that collision due to strong wind will occur, the task of acquiring examination data can be carried out smoothly, while lessening the possibility that the aerial vehicle will be buffeted by a gust of wind and downed. Also, a configuration can be adopted in which, by increasing the threshold value as it becomes easier to make up for delays caused by the task of acquiring examination data being interrupted, delays in the task of acquiring examination data become less likely to occur, while avoiding the risk of chance collisions of the aerial vehicle.

2-14. Aerial vehicle

In the embodiment, the aerial vehicle that flies autonomously is a rotary-wing aerial vehicle, but is not limited thereto. The aerial vehicle that flies autonomously may be an airplane-type aerial vehicle, and may also be a helicopter-type aerial vehicle, for example. In short, any aerial vehicle capable of being flown through operation by an operator and having a function for acquiring examination data can be used.

2-15. Apparatuses for Realizing Functions

The apparatuses for realizing the functions shown FIG. 5 are not limited to the above-mentioned apparatuses. For example, the functions realized by server apparatus 10 may be realized by drone 20 or controller 30. In this case, drone 20 or controller 30 serves as an example of an “An information processing device” of the present invention. In the case of drone 20 realizing the functions, instruction data may be transmitted to controller 30 as in the embodiment, although it is desirable for drone 20 itself to perform autonomous flight in accordance with the avoidance instruction since quick avoidance is possible. In all cases, the functions shown in FIG. 5 need only be realized by facility examination system 1 as a whole.

2-16. Category of Invention

The present invention can also be regarded as an information processing system (facility examination system 1 being one example) provided with An information processing devices and an aerial vehicle such as drone 20, other than the above-mentioned An information processing devices such as server apparatus 10 and the controller 30. The present invention can be regarded as an information processing method for realizing processing that is implemented by The information processing devices, and can also be regarded as a program for causing computers that control The information processing devices to function. The program regarded as the present invention may be provided in the form of a recording medium such as an optical disc or the like on which the program is stored, and may also be provided by downloading the program onto a computer via a network such as the internet, and installing the downloaded program to be utilizable.

2-17. Functional Blocks

Note that the block diagrams used in describing the above embodiment shows blocks in functional units. These functional blocks (constituent units) are realized by freely combining hardware and/or software. Also, the method of realizing the functional blocks is not particularly limited.

That is, the functional blocks may be realized using one apparatus that is physically or logically integrated, or two or more apparatuses that are physically or logically separated may be connected (e.g., by cable, wirelessly, etc.) and the functional blocks may be realized using these plurality of apparatuses. The functional blocks may also be realized by combining software with the above one apparatus or the above plurality of apparatuses.

Functions include determining (both meanings of “to judge” and “to decide”), judging, calculating, computing, processing, deriving, investigating, looking up/searching/inquiring, ascertaining, receiving, transmitting, outputting, accessing, resolving, selecting, choosing, establishing, comparing, assuming, expecting, regarding, broadcasting, notifying, communicating, forwarding, configuring, reconfiguring, allocating/mapping, and assigning, but are not limited thereto. For example, the functional block (constituent unit) that realizes the transmission function is called a transmitting unit or a transmitter. As mentioned above, the method of realizing any of the functional blocks is not particularly limited.

2-18. Direction of Input/Output

Information and the like (see “Information, Signals” section) can be output from a higher layer (or lower layer) to a lower layer (or higher layer). Input and output may also be performed via a plurality of network nodes.

2-19. Handling of Input/Output Information, etc.

Information and the like that has been input or output may be saved to a specific location (e.g., memory), and may also be managed with a management table. Information and the like that is input or output can be overwritten, updated or added. Information and the like that has been output may be deleted. Information and the like that has been input may be transmitted to other apparatuses.

2-20. Judgement Method

Judgement may be performed using a value (0 or 1) represented by 1 bit, may be performed by boolean operation (true or false), and may also be performed by numerical comparison (e.g., comparison with a predetermined value).

2-21 Processing Procedures, etc.

The order of the processing procedures, sequences, flowcharts and the like of the modes/embodiment described in the present disclosure may be changed, as long as there are no inconsistencies. For example, with regard to the methods described in the present disclosure, the elements of various steps are presented in an illustrative order, but are not limited to the specific order in which they are presented.

2-22. Handling of Input/Output Information, etc.

Information and the like that has been input or output may be saved to a specific location (e.g., memory), and may also be managed by use of a management table. Information and the like that is input or output can be overwritten, updated or added. Information and the like that has been output may be deleted. Information and the like that has been input may be transmitted to other apparatuses.

2-23. Software

Software is intended to be broadly interpreted to mean instructions, instruction sets, code, code segments, program code, programs, subprograms, software modules, applications, software applications, software packages, routines, subroutines, objects, executable files, execution threads, procedures, functions and the like, regardless of whether it is referred to as software, firmware, middleware, microcode or hardware description language, or by other names.

Also, software, instructions, information and the like may be transmitted and received via a transmission medium. For example, in the case where software is transmitted from a website, a server or other remote source using at least one of wired technology (coaxial cable, fiber optic cable, twisted pair wire, digital subscriber line (DSL), etc.) and wireless technology (infrared rays, microwaves, etc.), at least one of these wired and wireless technologies is included in the definition of a transmission medium.

2-24. Information, Signals

The information, signals and the like described in the present disclosure may be represented by use of any of a variety of different technologies. For example, data, instructions, commands, information, signals, bits, symbols, chips and the like that can be referred to throughout the above description as a whole may also be represented by voltages, currents, electromagnetic waves, magnetic fields or magnetic particles, optical fields, photons, or any combination thereof

2-25. “Determining”

The term “determining” (both meanings of “to judge” and “to decide”) used in the present disclosure may encompass diverse actions. “Determining” can, for example, include the actions of judging, calculating, computing, processing, deriving, investigating, looking up/searching/inquiring, (e.g., searching tables, databases and another data structures) and ascertaining being considered as the action of “determining”.

Also, “determining” can, for example, include the actions of receiving (e.g., receiving information), transmitting (e.g., transmitting information), inputting, outputting, and accessing (e.g., accessing data in memory) being considered as an act of “determining”. Also, “determining” can, for example, include the acts of resolving, selecting, choosing, establishing, comparing and the like being considered as the act of “determining”. In other words, “determining” can include an act that is an act of some sort as the action of “determining”. Also, “determining” may be read as “assuming”, “expecting”, “considering”, and the like.

2-26. Meaning of “based on”

The phrase “based on” that is used in the present disclosure does not mean “based only on” unless specifically stated otherwise. In other words, the phrase “based on” means both “based only on” and “based at least on”.

2-27. “Differ”

In the present disclosure, the phrase “A and B differ” may mean “A and B differ from each other”. Note that this phrase may also mean “A and B respectively differ from C”. Terms such as “distanced” and “integrated” may be similarly interpreted as “differ”.

2-28. “And”, “Or”

In the present disclosure, with regard to configurations that can be implemented with both “A and B” and “A or B”, a configuration described by one of these expressions may be a configuration by the other of the expressions. For example, a configuration described as “A and B” may be used as “A or B” as long as implementation is possible without any inconsistencies arising with respect to other descriptions.

2-29. Variations of Modes, etc.

The modes/embodiment described in the present disclosure may be used independently, may be used in combination, and may also be used through switching following execution. Also, notification of predetermined information (e.g., notification that “X is the case”) is not limited to that performed explicitly, and may be performed implicitly (e.g., by not performing notification of the predetermined information).

Although the present disclosure has been described in detail above, it will be apparent to a person skilled in the art that the disclosure is not limited to the embodiment described in the disclosure. The present disclosure can be implemented with revised and modified modes without departing from the spirit and scope of the disclosure which is defined by the description in the claims. Accordingly, the description of the present disclosure is intended as an illustrative description and does not have any restrictive meaning whatsoever with respect to the disclosure.

### REFERENCE SIGNS LIST

1 Facility examination system

2 Network

3 Anemometer

10 Server apparatus

20 Drone

30 Controller

101 Wind information storage unit

102 Wind predicting unit

103 Flight instructing unit

301 Instructed processing execution unit

What is claimed is:

1.-10. (canceled)

11. An information processing device comprising:
an acquiring unit configured to acquire wind information indicating windspeed and wind direction at a plurality of spots neighboring a facility targeted for examination;
a predicting unit configured to predict windspeed and wind direction at the facility based on the acquired wind information; and
an instructing unit configured to instruct, with regard to an aerial vehicle that flies around the facility and acquires examination data of the facility, flight that avoids colliding with the facility due to wind of the predicted windspeed and wind direction, before arrival of the wind.

12. The information processing device according to claim 11,
wherein the instructing unit gives the instruction at an increasingly earlier timing before arrival of the wind as a performance of the aerial vehicle decreases.

13. The information processing device according to claim 11,
wherein the instructing unit gives the instruction at an increasing earlier timing before arrival of the wind as an altitude of the aerial vehicle increases.

14. The information processing device according to claim 11,
wherein the instructing unit gives the instruction at an increasing earlier timing before arrival of the wind as a distance to the facility at a time of the aerial vehicle acquiring the examination data decreases.

15. The information processing device according to claim 11,
wherein the instructing unit gives the instruction at an increasing earlier timing before arrival of the wind as a remaining battery capacity of the aerial vehicle decreases.

16. The information processing device according to any one of claim 11,
wherein the instructing unit gives the instruction at an increasing earlier timing before arrival of the wind as a site where the facility is provided decreases in size.

17. The information processing device according to claim 11,
wherein the acquiring unit acquires weather information of a region including the facility, and
the predicting unit performs the prediction through weighting the windspeed indicated by the wind information acquired with regard to a spot that is shown as being located upwind by the acquired weather information.

18. The information processing device according to claim 11,
wherein the instructing unit gives the instruction in a case where the predicted windspeed or a change in the predicted windspeed is greater than or equal to a threshold value.

19. The information processing device according to claim 18,
wherein the instructing unit uses, as the threshold value, a value that depends on at least one of the performance of the aerial vehicle, the altitude of the aerial vehicle, the distance to the facility when the aerial vehicle acquires the examination data, the remaining battery capacity of the aerial vehicle, and the size of the site where the facility is provided.

20. An information processing method comprising:
acquiring wind information indicating windspeed and wind direction at a plurality of spots neighboring a facility targeted for examination;
predicting windspeed and wind direction at the facility based on the acquired wind information; and
instructing, with regard to an aerial vehicle that flies around the facility and acquires examination data of the facility, flight that avoids colliding with the facility due to wind of the predicted windspeed and wind direction, before arrival of the wind.
